(19) United States
(12) Patent Application Publication
(10) Pub. No.: US 2006/0140250 A1
(43) Pub. Date: Jun. 29, 2006

(54) Time resource allocation method of ultra wideband communication system

(75) Inventors: Ji Hye Kim, Seoul (KR); Kun Su Kim, Seoul (KR); Jong Sung Kim, Seoul (KR); Hang Dong Seong, Gyeonggi-do (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: LG Electronics Inc., Seoul (KR)

(21) Appl. No.: 11/318,725

(22) Filed: Dec. 27, 2005

(30) Foreign Application Priority Data
Dec. 28, 2004 (KR) 2004-0114341

(51) Int. Cl. H04B 1/69

(52) U.S. Cl. 375/130

(57) ABSTRACT

A time resource allocation method of ultra wideband (UWB) communication system is disclosed wherein transmission power is adjusted in a UWB communication system to appropriately allocate time resources of data transmission period. The present invention is such that determination is made as to whether there are time resources for allocation to a second UWB communication device if the second UWB communication device requests allocation of time resources while a plurality of first UWB communication devices are allocated with time resources of data transmission period. As a result of the determination, if time resources are lacking for allocation to the second UWB communication device, the first UWB communication device and the second UWB communication device measure a distance therebetween, and a wireless network region is divided by the measured distance and adjusted transmission power to enable to allocate time resource to the second UWB communication device.

This application claims the benefit of the Korean Patent Application No. P2004-114341, filed on Dec. 28, 2004, which is hereby incorporated by reference in its entirety.

### BACKGROUND OF THE INVENTION

1. Field of the Invention

The present invention relates to a time resource allocation method of an ultra wideband (UWB) communication system.

2. Description of the Related Art

UWB communication is related to a wireless communication technology using a wide frequency band of 2˜10 GHz. In other words, the UWB communication is a technology for exchanging data using ultra high frequency (UHF). Its transmission distance is short, i.e., around 10 meters while its data transmission speed is 100˜400 Mbps such that it is the fastest in the existing wireless communication technologies, while retaining low power consumption.

The UWB denotes a very wide frequency band that is used. The Federal Communications Commission (FCC) in the United States defines a UWB as wireless transmission technology occupying bandwidth more than 20% of a central frequency or a bandwidth greater than 500 MHz.

Such UWB communication systems can transmit radio signals at ultra low power using very short baseband pulses of several nanoseconds (width of pulse signal being in inverse proportion to bandwidth) to all frequency at the same time. The radio signals received by the UWB communication system are conventionally processed as in Code Division Multiple Access (CDMA).

Furthermore, in the UWB communication system, as a bandwidth increases, the transmission signal intensity may be decreased. As a result, the UWB may be inferred to be faithful to the basic principle of CDMA in that signals of low power are loaded in a wide frequency band for transmission, and signals of wide frequency band are again collected to reproduce signals of high power.

However, the UWB technology is not adequate for long distance transmission and reception of information since it uses a wide bandwidth. Consequently, the UWB communication system is getting much attention in next generation transmission technology for fulfilling the home networks or wireless communication technology for embodying ubiquitous network environment, rather than general broadcasting or mobile communication systems.

The most advantageous merit of the UWB communication over conventional systems is that it can transmit and receive data by employing existing frequency bands used by other systems. In other words, signals of UWB communication can decrease the power density in a frequency domain using a wide frequency band. Therefore, the system thus has high immunity against interference sources because its bandwidth and does not disturb other transmission systems even if superimposed in a frequency spectrum existing in other wireless communication signals.

This largely results in an anticipated usage of two characteristic properties of UWB communication system, namely:

First, radar technology for measuring a distance between UWB communication systems can be used for measuring a distance from a particular object by using reflection of radio wave.

Second, the technology can be used for transmission of AV (Audio/Video) signal owing to its low power and high speed data transmission. For example, control signals can be interchanged between digital information devices such as computers, digital television sets, digital camcorders and home theaters. Furthermore, moving picture data can be also transmitted.

The UWB communication system employs a time-sharing method where each UWB communication device monopolizes wireless communication medium during its allocated time to transmit data of its own desire.

The wireless communication method of UWB communication system is provided with a fixed time resource called a super frame. One super frame is largely divided into a beacon period for sending beacons and a data transmission period for transmitting substantial data.

The UWB communication devices constituting a network transmit beacons containing their information during the beacon period. Consequently, the UWB communication devices constituting the wireless network respectively receive beacons of other UWB communication devices via the beacon period to enable recognition of all the information of the UWB communication devices existing within the wireless network. Furthermore, the allocated information of time resource transmitting data can also be recognized during the beacon period.

If time is established for the respective UWB communication devices to transmit the data in the beacon period, each UWB communication device is allocated a time resource for transmitting its data in the data transmission period.

There are cases where a new UWB communication device requires allocation of time resource for transmitting predetermined data while the data transmission periods are all allocated to a plurality of UWB communication devices.

Under this circumstance, there is no way of accepting the allocation of time resource requested by the new UWB communication device because the data transmission period has allocated the time resource for transmitting the data to all the plurality of UWB communication devices.

In some cases, channels are changed to establish a new network. Alternatively, time that has already been assigned to the plurality of UWB communication devices is changed to reallocate the time resource required by the new UWB communication device.

However, the aforementioned assignment of time resource can be only possible when usable channels are available or the UWB communication devices already allocated with the time resources assign the already-allocated time resources.

If there is no usable channel available or it is impossible for the plurality of UWB communication devices to assign already-allocated time resources, the new UWB communication device cannot be allocated with time resource, resulting in disablement of data transmission.

### SUMMARY OF THE INVENTION

Accordingly, the present invention is directed to method and UWB communication system for allocating data transmission time resources among UWB communication devices. The time resources are allocated by determining whether a set of UWB communication devices communicating within a first wireless network region has a portion of its data transmission time resources available for allocation to another UWB communication device. If a portion of the time resources is available for allocation, the data transmission time resource is reallocated so that the other UWB communication device may transmit predetermined data in its newly allocated time resource.

One aspect of the invention also includes using a distance measurement between UWB communication devices to determine if a first wireless network region may be divided into two or more wireless network regions in order to accommodate one or more additional UWB communication devices. If it is determined that the division is possible based on the measurement, the first wireless network region is divided into multiple regions and the transmission power may be adjusted accordingly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

FIG. 1 is a schematic representation illustrating a wireless network of a UWB communication system.

FIG. 2 is a schematic representation illustrating a time resource allocated to UWB communication devices in a wireless network.

FIG. 3 is a schematic representation illustrating a wireless network of UWB communication devices according to an embodiment of the present invention.

FIG. 4 is a signal flowchart illustrating an allocation method according to an embodiment of the present invention.

FIG. 5 is an exemplary representation illustrating a state where time resources have been allocated according to an allocation method of the present invention in a wireless network.

### DETAILED DESCRIPTION OF THE INVENTION

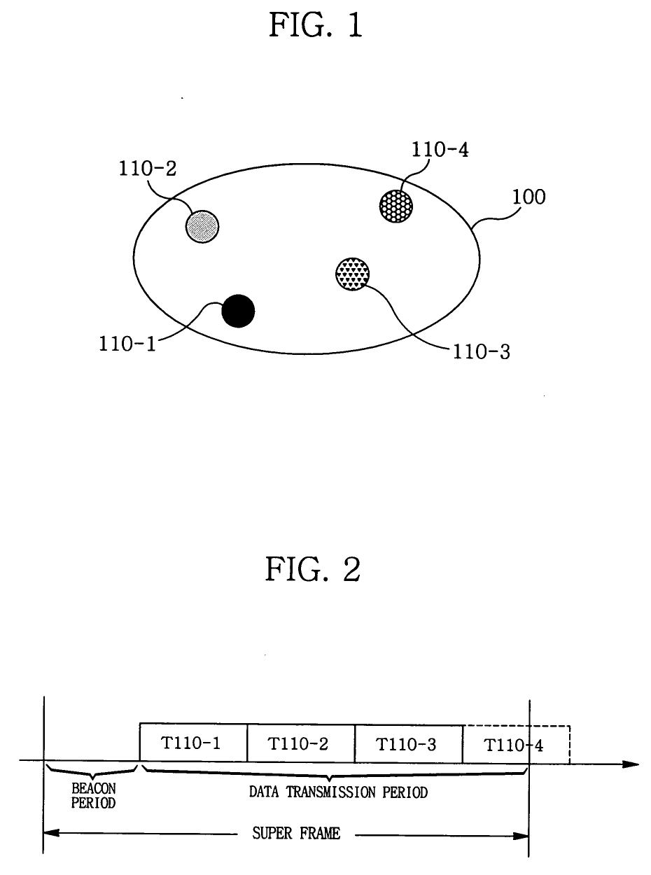

FIG. 1 is a schematic representation illustrating a wireless network of a UWB communication system, where reference numeral 100 denotes a wireless network region.

The wireless network region 100 is, for example, disposed therein with UWB communication devices 110-1, 110-2, and 110-3 which conduct UWB communication.

It is assumed that the UWB communication devices 110-1 110-2, and 110-3 in the wireless network region have transmitted and received beacons with one another within a beacon period illustrated in FIG. 2 to allocate time resources for monopolizing a wireless communication medium.

If a UWB communication device 110-4 located within a wireless network transmits a beacon in the beacon period and requests a time resource allocation, the UWB communication devices 110-1, 110-2, and 110-3 determine whether to allocate the time resource to a UWB communication device 110-4.

However, because time resources T110-1, T110-2, and T110-3 are already allocated to the UWB communication devices 110-1, 110-2, and 110-3 in the data transmission period, there may be no time resources available to be allocated for the UWB communication device 1104. Consequently, the UWB communication device 110-4 is not allocated with the time resource.

According to the present invention, if there is no time resource available to be allocated for the UWB communication device 110-4, the UWB communication devices 110-1, 110-2, 110-3, and 110-4 adjust mutual distance measurement and transmission power to enable allocation of the required time resources.

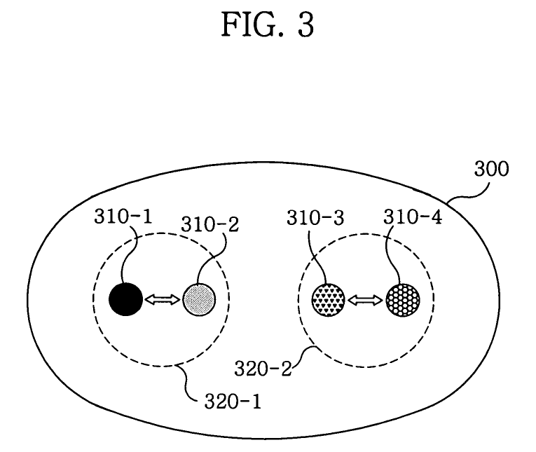

FIG. 3 is a schematic representation illustrating a wireless network of UWB communication devices according to an embodiment of the present invention, where reference numeral 300 denotes a first wireless network region. It is assumed that first UWB communication devices 310-1, 310-2 and 310-3 are located in the first wireless network region 300, conduct mutual UWB communication, allocate the time resources and transmit a predetermined data.

Under the circumstance, if a second UWB communication device 310-4 requires a time resource for transmitting a predetermined data, the first UWB communication devices 310-1, 310-2 and 310-3 and the second UWB communication device 310-4 determine whether there is time resource available for allocation.

As a result of the determination, if there is time resource available for allocation, time resource is allocated to the second UWB communication device 310-4 to allow transmitting the data.

However, if there is no time resource available for allocation to the second UWB communication device 310-4 as a result of the determination, the first UWB communication devices 310-1, 310-2 and 310-3 and the second UWB communication device 310-4 respectively receive data to be transmitted, or measure a distance among the UWB communication devices for transmitting the data to be respectively received.

Furthermore, a determination is made as to whether new second wireless network regions 320-1 and 320-2 are to be constructed using the measured distance.

For example, if the first UWB communication devices 310-1 and 310-2 exchange data therebetween, and the first UWB communication device 310-3 and the second UWB communication device 310-4 exchange data therebetween, it is determined that new second wireless network regions 320-1 and 320-2 are constructed. Otherwise, it is determined that it is impossible to construct new second wireless network regions 320-1 and 320-2.

As a result of the determination, if it is possible to construct new second wireless network regions 320-1 and 320-2, the first UWB communication devices 310-1 and 310-2 construct a new second wireless network region 320-1 to conduct the UWB communication. If it is not possible to construct new second wireless network regions 320-1 and 320-2, no allocation of time resource is made to the second UWB communication device 310-4.

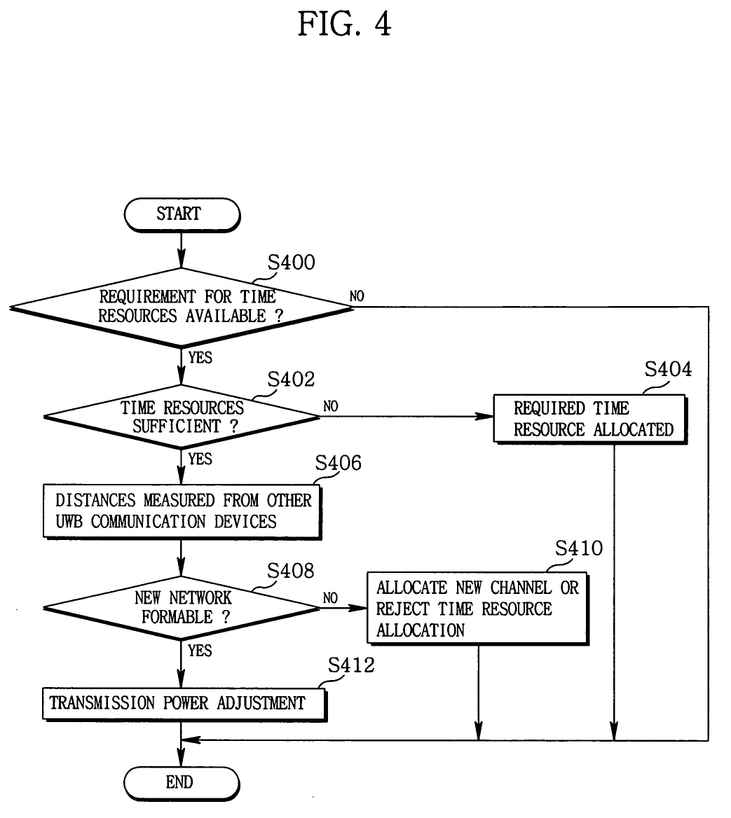

FIG. 4 is a signal flowchart illustrating an allocation method according to an embodiment of the present invention.

First, the first UWB communication devices 310-1, 310-2 and 310-3 located within the first wireless network region 300 and allocated with time resources determine whether the second UWB communication device 310-4 is positioned in the first wireless network region 300 and has requested allocation of time resource S400.

As a result of the determination, if the second UWB communication device 310-4 has requested allocation of time resource, the first UWB communication devices 310-1, 310-2 and 310-3 and the second UWB communication device 310-4 check whether they are under a state of accepting the allocation request of time resource S402. In other words, a determination is made as to whether the first UWB communication devices 310-1, 310-2 and 310-3 have allocated all the time resources in the data transmission period so that there is no time resource to be allocated to the second UWB communication device 310-4, or there remain enough time resources in the data transmission period so that time resource can be allocated to the second UWB communication device 310-4.

As a result of the determination, if there are enough time resources remaining in the data transmission period, time resource is allocated to the second UWB communication device 310-4 S404, and the second UWB communication device 310-4 monopolizes the wireless communication medium in the allocated time resource to enable transmission of predetermined data.

As a result of the determination, if time resource cannot be allocated to the second UWB communication device 310-4, the first UWB communication devices 310-1, 310-2 and 310-3 and the second UWB communication device 310-4 respectively measure distances from other UWB communication devices S406.

Furthermore, the first UWB communication devices 310-1, 310-2 and 310-3 and the second UWB communication device 310-4 use the measured distance to determine whether to divide the first wireless network region 300 into second wireless network regions 320-1 and 320-2 S408.

In other words, the first UWB communication devices 310-1, 310-2 and 310-3 and the second UWB communication device 310-4 determine whether it is possible to divide the first wireless network region 300 into second wireless network regions 320-1 and 320-2 because the distances to other UWB communication devices with which to exchange data are too short.

As a result of the determination, if it is impossible to divide the first network region 300 into second wireless network regions 320-1 and 320-2, a determination is made as to whether there is any useable new channel, and the first UWB communication devices 310-1, 310-2 and 310-3 and the second UWB communication device 310-4 allocate a new channel, or reject the allocation of time requested by the second UWB communication device 310-4 S410.

Furthermore, if it is determined that the first the first wireless network region 300 can be divided into second wireless network regions 320-1 and 320-2, the first UWB communication devices 310-1, 310-2 and 310-3 and the second UWB communication device 310-4 adjust the transmission power S412 to form new second wireless network regions 320-1 and 320-2 where the scope of wireless network region is narrowed.

Under this circumstance, the transmission power-adjusted first UWB communication devices 310-1, 310-2 and 310-3 and the second UWB communication device 310-4 verify with one another that beacons have been exchanged in the beacon period to form new networks, and notify the allocation information of time resources they own to other UWB communication devices via the beacons.

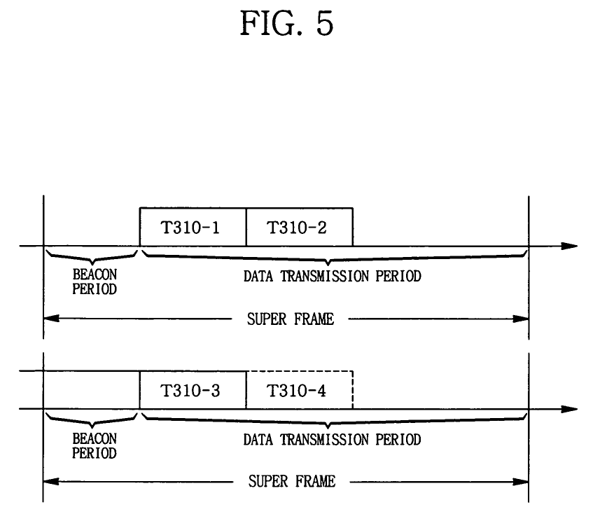

FIG. 5 is an exemplary representation illustrating a state where time resources have been allocated to the first UWB communication devices 310-1, 310-2 and 310-3 and the second UWB communication device 310-4 from the second wireless network region 320-1 and 320-2 newly formed via the allocation process of time resources thus described.

As shown in FIG. 5, the newly formed second wireless network region 320-1 is such that the first UWB communication devices 310-1 and 310-2 are respectively allocated with time resources T310-1 and T310-2 to transmit the data.

Under this circumstance, even if the first UWB communication devices 310-1 and 310-2 and the first UWB communication devices 310-3 and the second UWB communication device 310-4 are allocated with time resources T310-1, T310-2, T310-3 and T310-4 in the same time zone and transmit the data, there is no confliction of data transmission, and therefore, a safe transmission is possible because the first UWB communication devices 310-1, 310-2 and 310-3 and the second UWB communication device 310-4 adjust the transmission power to transmit data only within the newly formed second wireless network region 320-1 and 320-2.

As apparent from the foregoing, there is an advantage in the time resource allocation method of ultra wideband (UWB) communication system thus described according to the present invention in that first and second UWB communication devices located within a first wireless network region measure mutual distances to determine whether to form new second wireless network region where scope is narrowed due to adjustment of transmission power. If the second UWB communication device in the first wireless network region cannot be allocated with time resources to become unable to transmit data, such that according to the determination result, a new second wireless network region is formed to enable allocation of time resources required by the second UWB communication device.

The present invention has been described above in varied detail by reference to particular embodiment and figures. However, these specifics should not be considered as limitations on the scope of the invention, but merely as illustrations of some of the presently preferred exemplary embodiment. It is to be further understood that other modifications or substitutions may be made to one skilled in the art without departing from the broad scope of the invention. The modifications or substitutions should not be understood individually from the scope of the technical ideas or aspects of the present invention.

What is claimed is:

1. A time resource allocation method for an ultra wideband (UWB) communication system comprising:
determining whether a plurality of first UWB communication devices and a second UWB communication device can divide a first wireless network region;
dividing the first wireless network region into a plurality of second network regions if the division is possible as a result of the determination; and
allocating a data transmission time resource between the first and second UWB communication devices located in the divided plurality of second network regions.

2. The method as defined in claim 1, wherein determining whether the first wireless network region can be divided is conducted when the second UWB communication device requests an allocation of the data transmission time resource, wherein the plurality of first UWB communication devices are already allocated with at least a portion of the data transmission time resource within the first wireless network region.

3. The method as defined in claim 2 further comprising allocating at least a portion of the data transmission time resource to the second UWB communication device if the portion of the data transmission time resource is available for allocation within the first wireless network region before determining whether the first wireless network region can be divided.

4. The method as defined in claim 1, wherein determining whether the first wireless network region can be divided comprises:
measuring a distance between the plurality of first UWB communication devices and the second UWB communication device; and
determining whether the first wireless network region can be divided by an adjustment of transmission power as a result of the distance measurement.

5. The method as defined in claim 4, wherein measuring a distance comprises:
measuring a distance between the first and second UWB communication devices and UWB communication devices with which the first and second UWB communication devices are exchanging data.

6. The method as defined in claim 1, wherein the plurality of second wireless network regions comprises at least one or more devices among the plurality of first UWB communication devices and the second UWB communication device.

7. The method as defined in claim 1 further comprising recognizing that the second wireless network region has been formed via a beacon.

8. A method for allocating a data transmission time resource for an ultra wideband (UWB) communication system, the method comprising:
determining whether a plurality of first UWB communication devices communicating within a first wireless network region has available for allocation a portion of a data transmission time resource;
identifying a second UWB communication device; and
if the first wireless network region has a portion of the data transmission time resource available for allocation, allocating a portion of the data transmission time resource to the second UWB communication device.

9. The method as defined in claim 8, wherein:
if the first wireless network does not have unused portions of the data transmission time resource, measuring a distance between the plurality of first UWB communication devices and the second UWB communication device; and
determining whether the first wireless network region can be divided into two or more second wireless network regions as a result of the distance measurement.

10. The method as defined in claim 9, wherein if the first wireless network region can be divided into two or more second wireless network regions, adjusting transmission power of the two or more second wireless network regions to account for the division.

11. The method as defined in claim 9, wherein at least one of the second wireless network regions comprises one or more devices among the plurality of first UWB communication devices and the second UWB communication device.

12. The method as defined in claim 9 further comprising recognizing that the second wireless network region has been formed via a beacon.

13. The method as defined in claim 8, further comprising:
determining if an usable channel exists; and
if the usable channel exists, allocating the usable channel to the second UWB communication device.

14. The method as defined in claim 8, wherein identifying a second UWB communication device is performed by receiving a beacon from the second UWB communication device.

15. An ultra wideband (UWB) communication system, comprising:
one or more first UWB communication devices positioned in a locality, a portion of a data transmission time resource within a first wireless network region being allocated to each of the one or more first UWB communication devices;
a second UWB communication device positioned in the locality; and
a processing system for determining whether a portion of the data transmission time resource can be allocated to the second UWB communication device, and for allocating the portion of the time resource to the second UWB communication device if the allocation is possible.

16. The system as defined in claim 15, wherein the processing system is located at the one or more first UWB communication devices.

17. The system as defined in claim 15, wherein the processing system is further configured to measure a distance between the plurality of first UWB communication devices and the second UWB communication device, and to determine whether the first wireless network region can be divided into two or more second wireless network regions as a result of the distance measurement.

18. The system as defined in claim 16, wherein the processing system is further configured to adjust transmission power of the two or more second wireless network regions to account for the division.

19. The system as defined in claim 15, wherein the processing system is further configured to determine if a usable channel exists, and if the usable channel exists, to allocate the usable channel to the second UWB communication device.
